(19) United States
(12) Patent Application Publication
(10) Pub. No.: US 2022/0203844 A1
(43) Pub. Date: Jun. 30, 2022

(54) POWER GENERATION SYSTEMS AND METHODS FOR CONTROLLING CASCADED BATTERIES AND FUEL CELLS WITH SUPERCAPACITORS

(71) Applicant: CUMMINS INC., Columbus, IN (US)

(72) Inventors: Vivek A. SUJAN, Columbus, IN (US); Shivaram Kamat, Pune (IN); Jeffrey A. Green, Columbus, IN (US); Pinak Jayant Tulpule, Pune (IN); Timothy J. Proctor, Columbus, IN (US); Julie Furber, Indianapolis, IN (US); John Forgie, Columbus, IN (US)

(21) Appl. No.: 17/564,752

(22) Filed: Dec. 29, 2021

Related U.S. Application Data
(60) Provisional application No. 63/131,998, filed on Dec. 30, 2020.

(51) Int. Cl. B60L 15/20; B60L 50/70; B60L 50/60; B60L 50/40; B60L 58/16; B60L 58/30; B60L 58/40; B60L 50/75; H01M 10/48; H01M 10/42; H01M 16/00; H01M 8/04858; H01M 8/04537

(52) U.S. Cl. CPC B60L 15/2045; B60L 2240/54; B60L 50/60; B60L 50/40; B60L 58/16; B60L 58/30; B60L 58/40; B60L 50/75; H01M 10/48; H01M 10/425; H01M 16/006; H01M 16/003; H01M 8/04932; H01M 8/04611; H01M 2010/4271; H01M 2220/20; H01M 2250/20; B60L 50/70

(57) ABSTRACT

The present disclosure generally relates to power generation systems and methods for intelligently splitting power between, monitoring the life of, and/or controlling the power of one or more power sources, including at least one fuel cell and a battery and/or a supercapacitor, to maximize life of a vehicle and/or powertrain.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/131,998 filed on Dec. 30, 2020, the entire disclosure of which is hereby expressly incorporated herein by reference.

### TECHNICAL FIELD

The present disclosure generally relates to power generation systems and methods for controlling one or more power sources, including a battery, a fuel cell, and/or a supercapacitor.

### BACKGROUND

Power generation in hybrid electric vehicles (HEV), such as fuel cell electric vehicles (FCEV) or battery electric vehicles (BEV) requires optimal efficiency of the system. Engine transients reduce the efficiency of hybrid electric vehicles (HEV). However, targeting higher efficiency of any HEV necessitates higher energy storage transients.

The need for higher energy storage transients of HEVs may be met by using a battery. For example, a lithium-ion (Li-ion) battery has limited life and transient capabilities. A typical battery in any battery electric vehicle (BEV) application is sized to meet life, range, and C-rate limitation specifications or targets. C-rate is defined as a measure of the rate at which a battery is discharged relative to its maximum capacity.

Depending on the specific application and architecture, a battery may have one or more of these parameters as the limiting factor. If life of the battery is a limiting factor, the battery throughput can be reduced to improve the battery size or life. If range of the battery is a limiting factor, the battery life can be enhanced to improve its total cost of ownership (TCO). Alternatively, the charging frequency of the battery can be manipulated to change the limiting factor of the battery from range to battery life. When C-rate is a limiting factor, the effective C-rate can be reduced to improve the battery size.

Similarly, high transient power loadings on a fuel cell can negatively affect the fuel cell life of a FCEV. As is in the case of any HEV, this may be mitigated by using a Li-ion battery. Additionally, cycle aging limits in both cases may be addressed by absorbing the transient power loads. Power transients tend to be better regulated in BEVs, where energy storage is sized based on range rather than based on life. However, even in BEVs, increasing the total cycle life of the system is beneficial, as it influences the effective TCO.

In all of these instances, the limited life and transient capabilities of a battery or fuel cell may be significantly impacted by absorbing transient power loads via supercapacitors. For example, in electrified battery powertrain systems where the onboard Li-ion energy storage system is sized based on life requirements, it is conceivable that usage of one or more supercapacitors may reduce the amount of Li-ion battery needed to achieve the same life and transient response targets. Furthermore, use of a supercapacitor may also reduce the overall energy storage weight, cost, and volume needed to achieve the same target battery life and transient response.

Similarly, for electrified fuel cell powertrain systems, the life of the fuel cell in part depends on the ability of the fuel cell controller to manage the internal operating conditions, such as the airflow, coolant, and hydration levels. This is increasingly difficult during transients, and results in greater membrane electrolyte assembly (MEA) or bi-polar electrolyte plate wear or lower fuel cell life. The life of the fuel cell may be extended by reducing the transient demand off the fuel cell and shifting that effort to another component, such as the energy storage system. In parallel, the energy storage system may also be leveraging supercapacitors to extend the life of the Li-ion cells.

The transient power loading and total energy throughput on the battery or fuel cell may be reduced by using supercapacitors in combination with a Li-ion battery or fuel cell for the energy storage system of a vehicle. Doing so may extend the battery and/or fuel cell life. Moreover, an intelligent system and method is needed to control the source of power (e.g., from a battery, fuel cell, supercapacitor, or combinations thereof) used by any electrified powertrain system in real time.

### SUMMARY

Embodiments of the present invention are included to meet these and other needs. In one embodiment, a method of intelligently controlling one or more power sources of a powertrain system (“powertrain”) to maximize the life of the powertrain comprises measuring and/or estimating in real time a power loading requirement of the powertrain, identifying at least two variables that determine a power demand split in the powertrain, splitting power between the one or more power sources of the powertrain based on the identified variables, monitoring the life of the one or more power sources of the powertrain, and controlling power of the one or more power sources to maximize life of the powertrain.

The one or more power sources of the powertrain comprises at least one fuel cell and an energy storage system. In some embodiments of the present method, the energy storage system further comprises a battery. In some embodiments of the present method, energy storage system further comprises a supercapacitor.

The at least two variables that determine the power demand split between the one or more power sources of the powertrain comprises a power split variable (β) and a fuel cell transient loading variable (γ). In some embodiments of the present method, the at least two variables further comprise a fuel cell load following factor, a. Embodiments of the method may further comprise correcting the value of the at least two variables to compensate for the expected impact on life of the energy source system.

In some embodiments, the method further comprises determining the life of the one or more power sources. In some embodiments of the present method, the energy storage system comprises at least one battery and at least one supercapacitor. The power split variable (β) determines the power split between the battery and the supercapacitor.

Some embodiments of the present method comprises identifying variables that determine power demand split in the powertrain. These method steps may also comprise using data generated offline. In some embodiments, the data generated or incorporated in the method offline is based on a Look Up Table. In some embodiments, the data generated or incorporated offline comprises incorporating predictive mapping or routing information. In some embodiments, the predictive mapping or routing data is acquired from electronic or online routing sources.

In some embodiments of the present method, the powertrain is comprised in a vehicle. The vehicle may be an electric vehicle. The electric vehicle may be a fuel cell electric vehicle (FCEV) or a battery electric vehicle (BEV).

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1 is an illustration of the different energy storage system architecture manifestations in a vehicle or powertrain;

FIG. 2 is a schematic of the circuits illustrating the various energy storage system architectures in a vehicle or a powertrain with a DC/DC;

FIG. 3 is a flowchart illustrating the steps involved in the intelligent control of the power split amongst the storage elements;

FIG. 4A is a graph illustrating the route profile, with speed and time of the vehicle or a powertrain;

FIG. 4B is a graph illustrating the power split between the fuel cell, the Li-Ion battery and the supercapacitor in a vehicle or a powertrain;

FIG. 5 is graph showing a supercapacitor life modelling method and an intelligently controlled throughput (“thruput”) method of the present disclosure;

FIG. 6 is a graph showing Li-ion battery life modelling using a micro-cycling/pulsewise degradation method for a first chemistry type (e.g., Type 1) of Li-ion batteries and the intelligently controlled throughput method;

FIG. 7 is a graph showing Li-ion battery life modelling using a micro-cycling/pulsewise degradation method for a second chemistry type (“Type 2”) of Li-ion batteries and the intelligently controlled throughput method;

FIG. 8 is a graph showing Li-ion battery life modelling using a micro-cycling/pulsewise degradation method for a third chemistry type (e.g., Type 3) of Li-ion batteries and the intelligently controlled throughput method;

FIG. 9 is a graph showing battery life calculations using the micro-cycling/pulsewise degradation method of FIGS. 6-8 (e.g., Method 1) as compared to the present intelligently controlled throughput method (e.g., Method 2);

FIG. 10 is a diagram of the combined model for the Li-ion battery and the supercapacitor for setting up a DoE;

FIG. 11 is a graph showing the typical waveforms for an embodiment in which the utilization of the capacitor is in the range of about 50% to about 68% of its capacity;

FIG. 12 is a graph illustrating the current split factor μ, based on rule based splitting;

FIG. 13 illustrates the impact of the number of battery recharges on required battery size (based on throughput life) as evaluated for three different applications and multiple routes in a BEV;

FIG. 14 illustrates the feasible capacitor/battery energy combinations and the resulting system and financial impacts, as evaluated for a FCEV in three different applications for various battery chemistry compositions;

FIG. 15 illustrates the feasible capacitor/battery energy combinations and the resulting system and financial impacts, as evaluated for a BEV in a varying range of daily recharges; and

FIG. 16 illustrates the battery life extension (based on throughput life) when using a capacitor in a specific application that recharges one time per day.

### DETAILED DESCRIPTION

Supercapacitors (SC), also called ultracapacitors, are high-capacity power sources with a capacitance value much higher than other types of capacitors. Typically, supercapacitors have about 10 to about 100 times more energy per unit volume or mass compared to electrolytic capacitors. However, supercapacitors have lower voltage limits compared to other capacitors.

Supercapacitors can accept and deliver charge much faster than batteries. They can achieve a high power density up to 50 times of that which is achieved by batteries. Supercapacitors can also tolerate more charge and discharge cycles compared to rechargeable batteries.

In addition, supercapacitors can sustain about 1 million charge cycles and have an operating temperature that ranges from about −50° C. to about 70° C. The manufacturing process of supercapacitors does not involve harmful materials or toxic metals, which allows them to be certified as a disposable component. Furthermore, supercapacitors are often more efficient than batteries, and require minimal maintenance compared to batteries.

Supercapacitors are constructed in a manner similar to electrolytic capacitors, and have a liquid or wet electrolyte between their electrodes. Based on their chemical compositions, supercapacitors can be characterized as aqueous electrolytic supercapacitors, or as ionic liquid supercapacitors. Types of supercapacitors may include, but are not limited to, hybrid supercapacitors or organic electrolytic supercapacitors. Different supercapacitor compositions have different working characteristics and specifications.

Supercapacitors do not have a dielectric. Both plates in a supercapacitor are soaked in an electrolyte, and separated by a very thin insulator. A supercapacitor insulator is made of material, such as carbon, paper, or plastic, and acts as a separator.

When supercapacitor plates are charged, an opposite charge forms on either side of the insulator, creating an electric double-layer. This double-layer may be about one molecule thick unlike a dielectric in a conventional capacitor that might range in thickness from a few microns to a few millimeters. Thus, supercapacitors are often referred to as double-layer capacitors or electric double-layer capacitors.

Electric double-layer capacitors (EDLCs) use carbon electrodes or derivatives with much higher electrostatic double-layer capacitance than electrochemical pseudo-capacitance. Electrochemical pseudo-capacitors use metal oxide or conducting polymer electrodes with a high amount of electrochemical pseudo-capacitance. Hybrid capacitors, such as the Li-ion capacitors, use electrodes with differing characteristics: one exhibiting mostly electrostatic capacitance and the other exhibiting mostly electrochemical capacitance.

Hybrid capacitors may have an aqueous, organic, and/or ionic electrolyte. An aqueous electrolyte is water based and may be acidic, alkaline, or have salts. An aqueous electrolyte typically has a low functional temperature range. An organic electrolyte is more expensive, but has a wider functional temperature range. An ionic electrolyte comprises liquid salts.

Supercapacitors have an inherently long cycle life, which may comprise millions of charge/discharge cycles. This is true, particularly when supercapacitors are compared to Li-ion batteries that may only have a cycle life of about several thousand charge/discharge cycles. Additionally, supercapacitors have inherently short response times (e.g., about 40-300 milliseconds, ms) due to a low equivalent series resistance compared to Li-ion batteries (e.g., about 500 ms).

Various energy storage system (ESS) architecture systems and method embodiments of the present disclosure may be used in a vehicle 100 or a powertrain system (“powertrain”) 200. In one embodiment, a powertrain 200 system of the present disclosure may be used or comprised in any application including, but not limited to on or off roads or highways, underwater, high altitudes, sub-Saharan, mobile, stationary, and/or industrial applications. In one embodiment, the powertrain 200 system may be comprised by a machine, an equipment, or an industrial facility or a method of producing or operating the same. In another embodiment, a powertrain 200 system may be separate and distinct from a vehicle 100.

A vehicle 100 may be any standard, recreational, or industrial vehicle or automobile, including, but not limited to a car, a truck, a boat, a train, a plane, a helicopter, a submarine, etc. In one embodiment, the vehicle 100 is an electrified vehicle. In one embodiment, a powertrain 200 system may be comprised in or by a vehicle or an electrified vehicle 100. In some embodiments, a powertrain 200 may be configured to be comprised by (e.g., inside, within, beside, atop, and/or underneath) the vehicle 100.

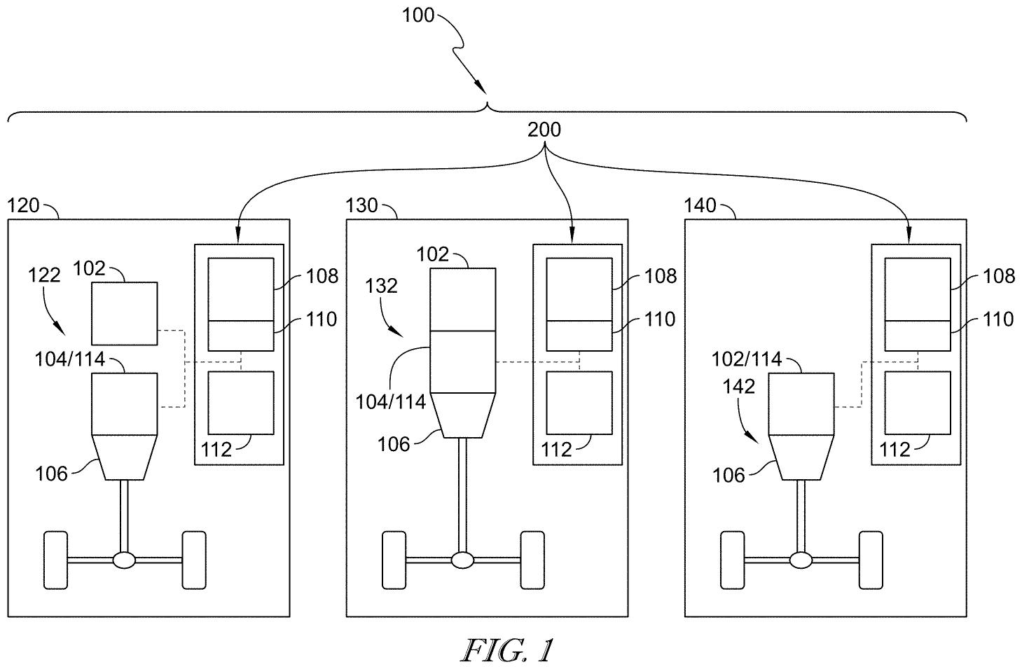

Provided herein are various ESS architecture systems and methods utilized by or in a vehicle 100 (e.g., 120, 130, and 140) and/or a powertrain 200 (e.g., 202, 204 206, and 208). For example, FIG. 1 illustrates a fuel cell electrified vehicle (FCEV) energy storage system 122 in a vehicle 120, a parallel hybrid energy storage system 132 in a vehicle 130, and a battery electrified vehicle (BEV) energy storage system 142 in a vehicle 140. The different vehicle 100 embodiments comprise a fuel cell 102, a motor generator 104 (comprising a motor 114), a transmission 106, a supercapacitor 108, a DC/DC converter 110, and/or a battery 112.

In some vehicle 100 or powertrain 200 embodiments, the DC/DC converter 110 may be located next to the battery 112 (only) side. In some embodiments, the DC/DC converter 110 may be located next to the supercapacitor 108 (only) side. In additional embodiments, the DC/DC converter 110 is located between the battery 112, the supercapacitor 108, and/or the motor 114 (see FIG. 1).

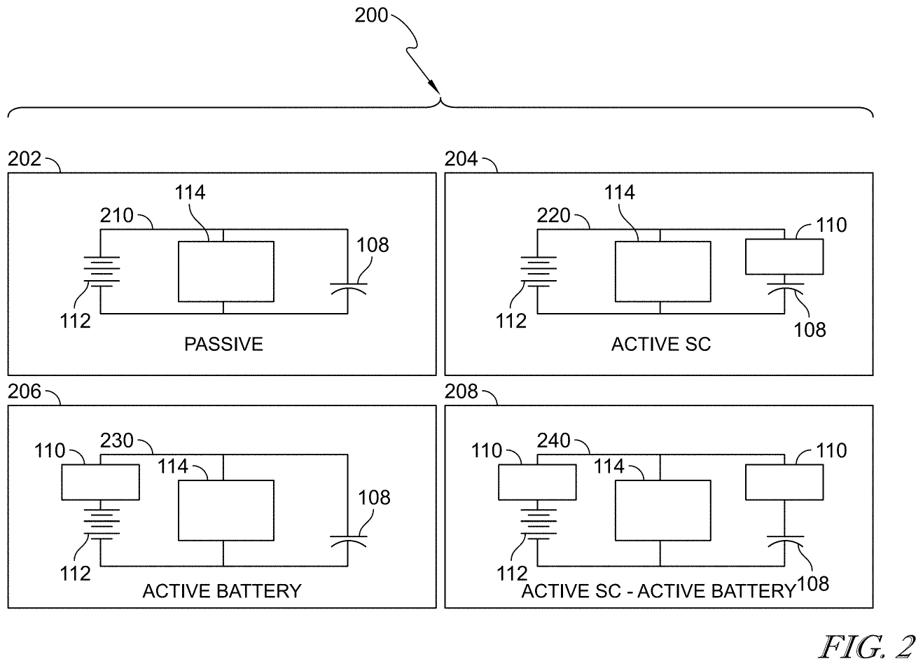

FIG. 2 illustrates different power circuits or systems (210, 220, 230, and 240) that may be comprised in various powertrain 200 architectures (202, 204, 206, and 208) of the present disclosure. In one embodiment, a power circuit 210 has a passive architecture with a battery 112, a supercapacitor 108, and a motor 114 comprised in a vehicle 100 or a powertrain 202. In one embodiment, the circuit 220 has an active architecture with an active supercapacitor (SC) 108 comprised in a vehicle 100 or a powertrain 204. This embodiment 220 may comprise a DC/DC converter 110 in series with a supercapacitor 108, a battery 112, and a motor 114 (see FIG. 2).

The power circuit 230 shows an active architecture with an active battery 112 comprised in a vehicle 100 or a powertrain 206. This power circuit 230 embodiment may comprise a battery 112 in series with a DC/DC converter 110, a motor 114, and a supercapacitor 108. Another circuit 240 shows an active architecture with an active battery 112 and an active supercapacitor (SC) 108 comprised in a vehicle 100 or a powertrain 208. This embodiment 240 may comprise a battery 112 in series with a DC/DC converter 110, a supercapacitor 108 in series with a second DC/DC converter 110, and a motor 114 (see FIG. 2).

All variants and variations of electric vehicle 100 or powertrain 200 architectures using a battery 112 have limitations in terms of maximum power and energy density, charging and discharging time, maximum range of currents and voltages, and regenerative power management. If these limitations are exceeded, it may result in a need for an oversized battery 112, untimely degradation of the battery, reduced overall performance, reduced battery life with a need for frequent replacements, or a high overall life cycle cost. A hybrid ESS that includes two or more storage elements (e.g., energy sources) of different technologies can mitigate these shortfalls to varying degrees.

An optimized combination of the two or more storage elements is determined in view of the vehicle 100 specification and/or powertrain 200 architecture, systems, or methods 300 of the present disclosure. The vehicle 100 or powertrain 200 specifications, in some embodiments, are combined with route targets or specifications that are setup in a simulation or real world environment. Once the optimized combination of routing and vehicle/powertrain specifications are selected (e.g., by a user, an operator, or a computer algorithm), the vehicle 100 or powertrain 200 can be intelligently controlled in real time by a system or method 300 in order to provide the necessary power to one or more power sources and/or storage elements for efficient and optimal performance of all, particularly a fuel cell 102.

In one embodiment, there may be more than two storage elements. In one embodiment, there may be two storage elements. In some embodiments, the two storage elements comprise a supercapacitor 108 and a battery 112.

In some embodiments, the battery 112 is a Li-ion battery. The battery 112 or supercapacitor 108 life may be modelled as a function of a chemistry. A supercapacitor life model may be set up based on an assumed end-of-life (EOL) capacity.

A split factor variable is determined based on the structure and the design of an experiment (DoE) set up for a combined system. This split factor variable determines the power demand split between the two or more storage elements (e.g., power sources). To develop an architecture that makes use of the properties of a supercapacitor 108 to minimize transient power impact on Li-ion battery 112 life, the range of the power demand split may be based off a series of models simulating various conditions depending on the desired applications and corresponding or related duty cycles of the vehicle 100 or powertrain 200.

In another embodiment, a fuel cell 102 is coupled with a supercapacitor 108 and a Li-ion battery 112. Fuel cell 102 failure cases illustrate localized cell component degradation, primarily caused by flow-field dependent non-uniform distribution of reactants. These spatiotemporal variations in fuel cell 102 state variables under transient load cycles can result in performance degradation. Often suboptimal or poor fuel cell 102 performance under such conditions is related to platinum loss and consequent reduction in electrochemical active surface area of the fuel cell 102. Such a cyclic operation leads to multiple degrading side reactions, eventually rendering the fuel cell 102 unable to provide the requested power demand and catastrophic fuel cell failure.

To avoid such fuel cell 102 operational performance failures, and to preserve the life of the fuel cell 102 (and other power sources or storage components), the fuel cell life may be assessed. In addition, the degree to which the fuel cell 102 is able to provide the needed vehicle 100 or powertrain 200 power in comparison to that provided by the ESS (e.g., the battery 112 and/or supercapacitor 108) may be determined during and/or by the intelligent control method 300 of the present disclosure. In some embodiments, a constraint is based on the assumption that the system is charge sustaining (i.e. energy storage system SoC_{mission start}≈SoC_{mission end}). In some embodiments, this constraint is relaxed, such as in a range extended FCEV (REEV; REFCEV).

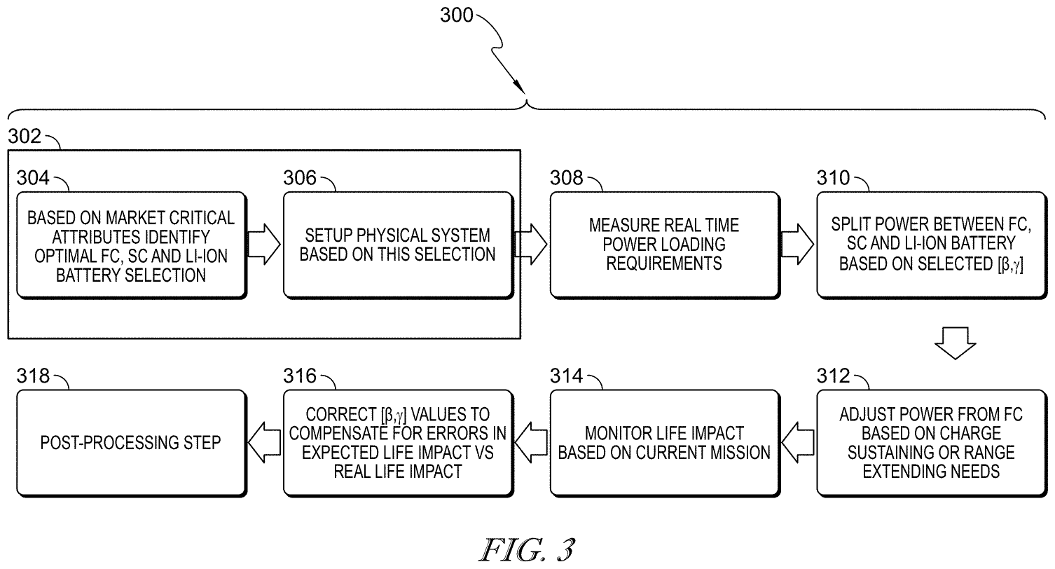

The flowchart shown in FIG. 3 illustrates method 300 steps (302-318) involved in the intelligent control of the power demand split amongst the power sources (102, 108, 112) provided herein. For example, the architecture of the power sources (102, 108, 112) in a vehicle 100 or powertrain 200 is established and the expected life of the power sources (102, 108, 112) is ascertained in step 302. The optimal fuel cell (FC) 102, supercapacitor (SC) 108, and Li-ion battery 112 (e.g., power sources) are identified and selected based on critical system attributes in step 304 required for proper operation and/or performance.

Once the physical system is set up based on those power source selections in step 306, the intelligent control method 300 of the system is executed in real time. The power loading requirements of the vehicle 100 or powertrain 200 are measured in step 308. These system requirements depend on the power needs of the vehicle 100 or powertrain 200 as based on its operational mission.

The power demand is split between fuel cell (FC) 102, supercapacitor (SC) 108, and Li-ion battery 112, and is calculated based on selected parameters in step 310. These parameters may be defined as the energy storage system (ESS) power split variable (β) and the fuel cell 102 transient loading variable (γ). The power demand split is determined by creating a weighted function that splits the power demand between the various power producing sources (102, 108, 112) by adjusting the weights and shifting the power demand between the different sources (102, 108, 112). The optimal weights for the power demand split are determined by assessing a cost function.

The power from fuel cell 102 is adjusted based on charge sustaining or range extending needs of the vehicle 100 or powertrain 200 in step 312. The variable a is the fuel cell 102 load following factor and may be uniquely determined to achieve a charge sustaining conditions. The life of the power sources (102, 108, 112) is monitored based on the mission in step 314. The parameter values are corrected to compensate for errors in the expected life when compared to the real life in step 316. The control of the system in real time is directly related to the values selected for the variables β and γ as well as on the charge sustaining or range extending needs of the powertrain 200.

A prime mover effort is defined as the primary source of power of the vehicle 100 or powertrain 200 and of the effort that the vehicle 100 or powertrain 200 applies. In some embodiments, real time control will not be able to determine the variable α, and a more typical “rubber band” controller may be employed where the prime mover effort is a function of the deviation of the energy storage system (ESS) net instantaneous state of charge (SoC) from the SoCₛₜₐᵣₜ or SoC_{target}. Thus, the further the deviation in SoC, the more the effort by the prime mover to return to target, which is accomplished by increasing or by decreasing its power output.

Since real life degradation may be different compared to the targeted degradation, the specific pairing for β and γ can be adjusted based on data generated, determined, and/or gathered offline and/or online. Offline data and/or information may originate from an offline design of experiment (DoE). In some embodiments, the data gathered is based on predictive mapping or routing information. In some embodiments, the data may be in the form of a Look Up Table (LUT).

In some embodiments, a LUT is a simple deterministic table where given certain inputs, a calibrated value of a variable from the table can be determined offline, looked up (or interpolated) and to control the system. For example, β and γ may be the inputs to a LUT that is calibrated offline to create a value for life loss of a Li ion battery.

If a specific life loss of a Li ion battery L_{Li-ion} is being targeted but a different value ΔL_{Li-ion} is observed over the test period, to correct this discrepancy going forward β and γ parameters will need to be adjusted.

To determine those parameters (e.g., α, β, and γ), a LUT may be used. Illustratively, use of a LUT is often the simplest and most efficient way to determine the values of α, β, and γ parameters. Alternatively, any other method known in the art that is able to generate the α, β, and γ values and/or parameters may also be used in the present method 300 and systems.

In some embodiments, life loss (AL) may be described as:

[ΔL_{FC}, ΔL_{SC}, ΔL_{Li-ion}]=fn(β, γ).

In some embodiments, life loss (ΔL) may be described as:

[δβ, δγ]=F(ΔL_{FC}^{Tgt}−ΔL_{FC}^{Real},ΔL_{SC}^{Tgt}ΔL_{SC}^{Real}, ΔL_{/LiIon}^{Tgt}−ΔL_{LiIon}^{Real} )

where β is an output of a LUT with inputs of ΔL_{FC}^{Tgt}−ΔL_{FC}^{Real},ΔL_{SC}^{Tgt}ΔL_{SC}^{Real}, ΔL_{/LiIon}^{Tgt}−ΔL_{LiIon}^{Real}, and γ is similar in form. In some embodiments, LUTs may be more complex such as a dependent function.

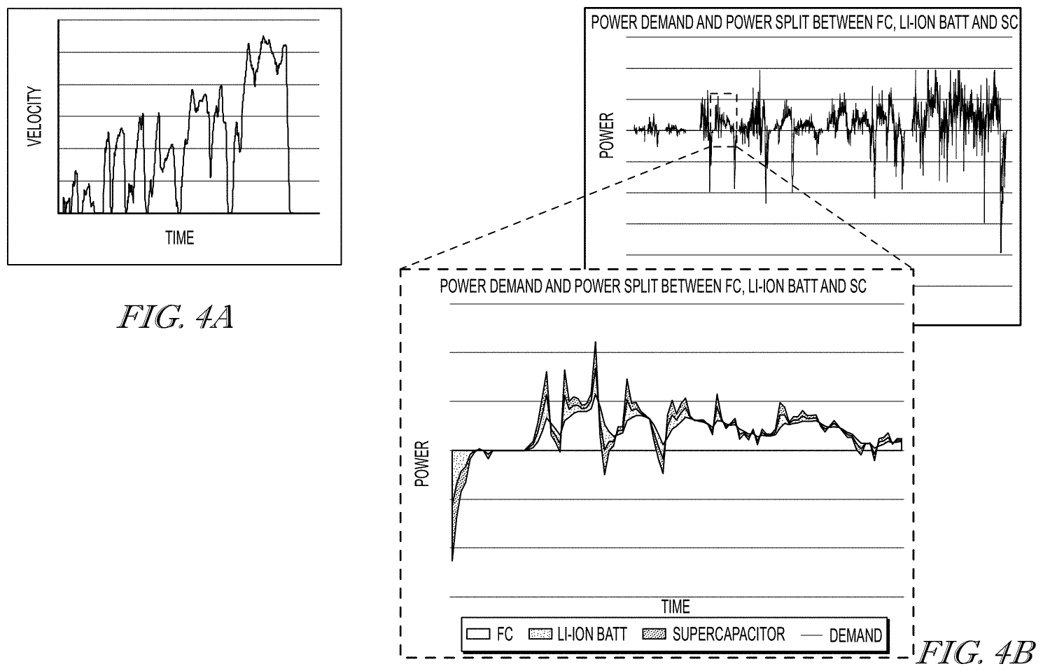

FIGS. 4A and 4B illustrate an example of this operational power split in a heavy-duty vehicle 100 on a specific route having a route profile where α, γ, and β may have defined properties, characteristics, and/or values. FIG. 4A illustrates the route profile, with speed and time of the vehicle 100, helps determine the power split.

FIG. 4B illustrates the power split by the various power producing devices on board (e.g., the fuel cell 102, the battery 112, and the supercapacitor 108). While the battery 112 and supercapacitor 108 can also provide negative power (e.g., regenerative braking), the fuel cell 102 cannot. Therefore, a specific power split is measured, determined, and/or estimated based on constant values of α, γ, and β.

Any process, method, calculation, formula, and/or algorithm to determine life of a battery 112, a fuel cell 102, and/or a supercapacitor 108 may be used by the present method 300, including but not limited to any physics or stochastic based methods. In an illustrative embodiment, a throughput based life model is used for determining the life of the supercapacitor 108, the fuel cell 102, and/or the battery 112. In some embodiments, a model different from a throughput based life model is used to determine the life of the supercapacitor 108, the fuel cell 102, and/or the battery 112.

In some embodiments, it is assumed that the supercapacitor 108 has good capacity retention up to a cell temperature of about 40° C. In some embodiments, an end-of-life (EOL) capacity of the supercapacitor 108 at about 80% is assumed. In some embodiments, the supercapacitor 108 has a life of about 1 million cycles and can perform up to a cell temperature of about 40° C.

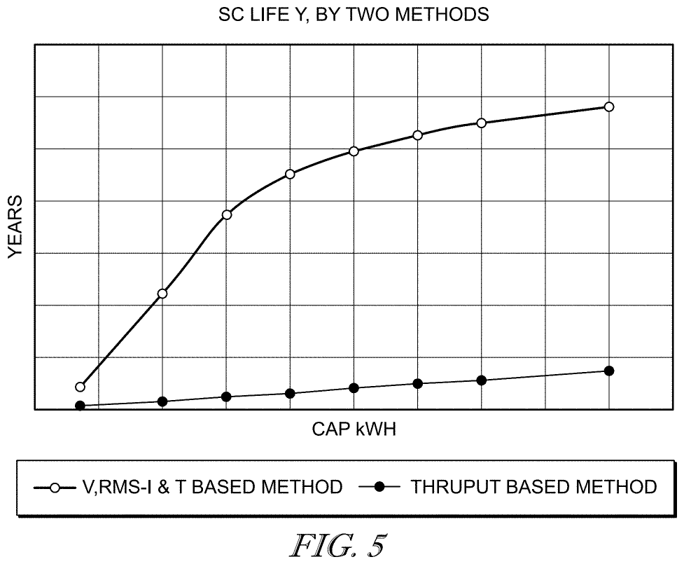

In some embodiments, a supercapacitor 108 life modelling method was employed. An exemplary life modelling method of the supercapacitor 108 measures supercapacitor voltage, RMS current, and/or temperature. For example, the life of a supercapacitor 108 is shown in FIG. 5 and was determined using such a method and compared to the present intelligently controlled throughput (“thruput”) method 300.

In some embodiments, a throughput based life model 300 is an intelligently controlled method 300 that is used for determining the life of a Li-ion battery 112. Such a throughput based life model 300 uses the value of the number of charge or discharge cycles that may be performed on the battery 112 before the ability to move energy to or from the battery 112 reaches zero. This variable is dependent on battery 112 chemistry and represents the total energy throughput for a battery 112 of any given size.

Any further cycle activity will gradually consume the total energy allowance and the decay will represent the State of Health (SOH). The SOH is a measure of how much capacity or throughput energy is left in a battery 112 or supercapacitor 108. In some embodiments, a model different from a throughput based life model 300 is used to determine the life of the Li-ion battery 112.

For example, a micro-cycling/pulsewise degradation method for typing a first chemistry (e.g., Type 1) of Li-ion batteries 112 may be employed. An exemplary life modelling method of the Li-ion Type 1 battery 112 is based on Type 1 chemistry.

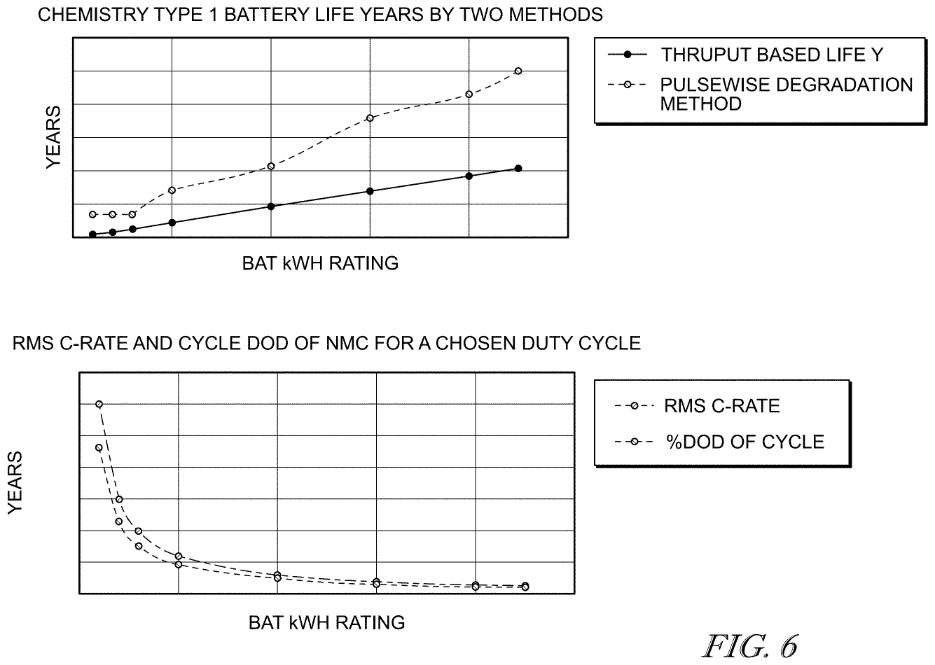

FIG. 6 illustrates the life and C-rate as a function of battery 112 kWh calculated using the present throughput method 300 and the pulsewise degradation method as described.

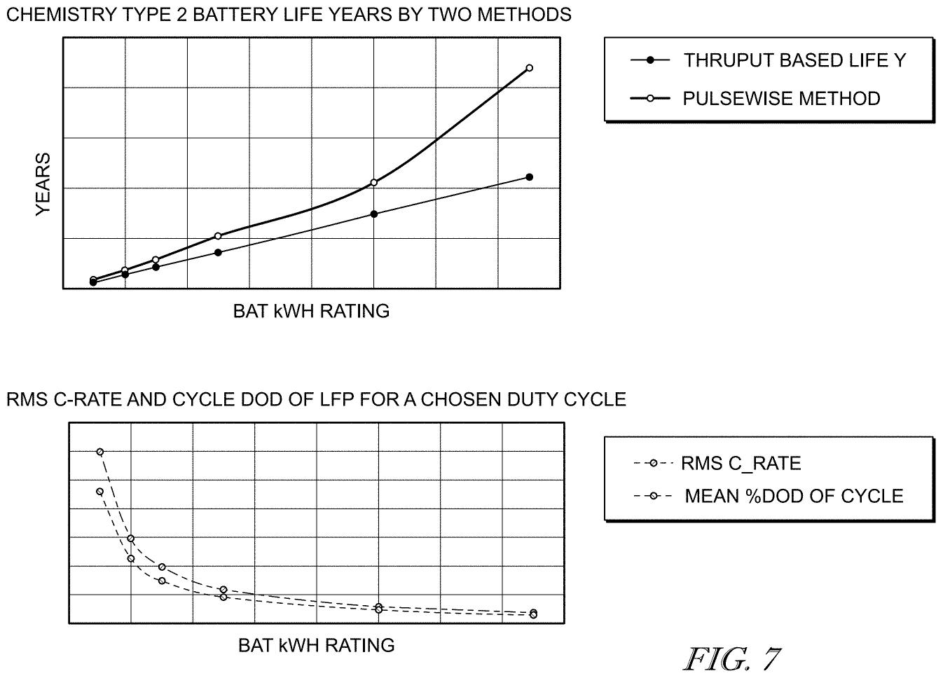

In some embodiments, a micro-cycling/pulsewise degradation method for a second chemistry (e.g., Type 2) of Li-ion batteries 112 is employed. An exemplary life modelling method of the Li-ion Type 2 battery 112 is based on Type 2 chemistry. FIG. 7 illustrates the life and C-rate as a function of battery 112 kWh calculated using the throughput method 300 and the pulsewise degradation method as described.

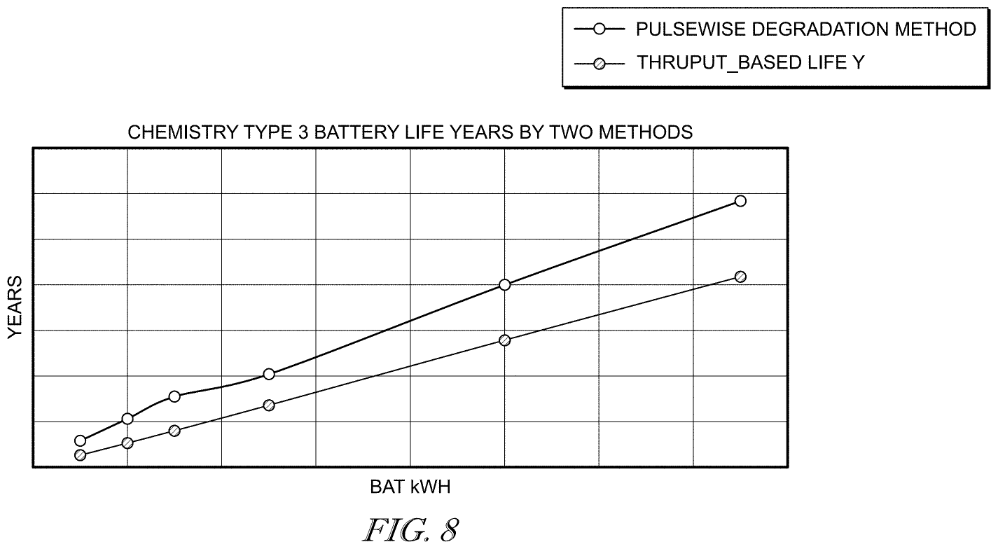

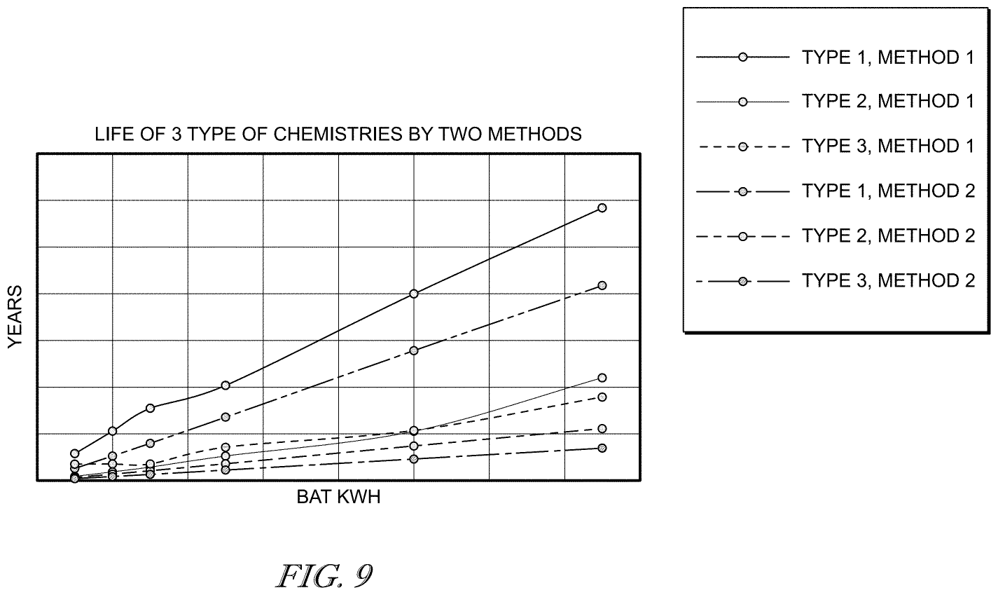

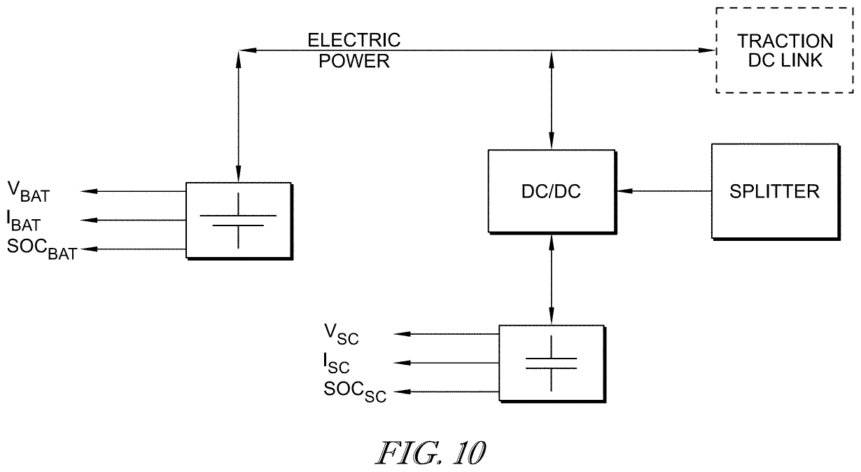

In some embodiments, a micro-cycling/pulsewise degradation method for a third chemistry (e.g., Type 3) of Li-ion batteries 112 is employed. An exemplary life modelling method of the Li-ion Type 3 battery 112 is based on Type 3 chemistry. FIG. 8 illustrates the life calculated using the present throughput method 300 and the pulsewise degradation method as described. FIG. 9 compares the life calculations based on utilization of the microcycling/pulsewise degradation method and the present throughput method 300 for the first, second, and third type of chemistries (e.g., Types 1, 2, and 3).

The specific pairing for β and γ can be adjusted based on the data gathered from the offline design of experiment (DoE), as mentioned earlier. In one embodiment, the offline DoE may be set up and processed based on certain conditions or parameters as discussed below, such as the total power demand

The total power demand (P_{DMD}) is the sum of and is split between the fuel cell (FC) power (P_{FC}) and the power of the ESS (P_{ESS}). Power of the ESS (P_{ESS}) is the sum of P_{ESS1}, power obtained from one or a first component of the energy storage system (e.g., the battery 112) and P_{ESS2}, power obtained from a second component of the energy storage system (e.g., the supercapacitor 108).

P_{DMD}=P_{FC}+P_{ESS}

In some embodiments, P_{FC}=α·(γ·P_{DMD}ⁱ+(1−γ)·P_{FC}ⁱ⁻¹).

This is only one of several possible functional representations of P_{FC} where the transient loading variable y, may be critical to aging.

P_{ESS}=P_{ESS1}+P_{ESS2}

(LiIon)P_{ESS1}β·P_{ESS}

(SC)P_{ESS2}=(1−β)·P_{ESS}

In some embodiments, the loss of life of the fuel cell is determined as described below.

Life loss of the fuel cell (ΔL_{FC}) is given by:

ΔL_{FC}=F(Temp, time, V_{cell}, x_{O}_{₂}, x_{H}_{₂}_{O}, γ, P_{FC}/P_{FC}_{ₘₐₓ}).

Life loss of the supercapacitor (ΔL_{SC}) is given by:

ΔL_{SC}=G(Temp, time, (1−β)·P_{ESS},ΔV,SoC).

Life loss of the Li-ion battery (ΔL_{Li-ion}) is given by:

ΔL_{Li-ion}=H(Temp, time, —·P_{ESS},Cᵣₐₜₑ,Ah,SoC).

Where x_{O}_{₂}, x_{H}_{₂}_{O} is the fraction of oxygen and water/humidity, ΔV is the change in voltage, and Ah is Amp hours, a measure of energy. In some embodiments, the loss of life (ΔL) of one or more of the power sources may be described differently.

A design of experiment (DoE) is performed to explore values of variables β and γ. This DoE may be performed offline. The variable α may be uniquely determined based on γ, such that there exists a charge sustaining solution.

This may be relaxed if a range extender solution is needed as is in the case of BEVs. Each unique combination of ESS elements as a function of β and γ will have a unique total TCO. In some embodiments, the optimal control may depend on the TCOₘᵢₙ solution. With each setting of β and γ, the life loss of the fuel cell 102, supercapacitor 108, and Li-ion battery 112 devices may be determined.

The performance of a DoE depends on the setup of the ESS. Referring now to FIG. 9, it illustrates an embodiment of the setup of the combined model for the Li-ion battery 112 and the supercapacitor 108. The battery 112 and supercapacitor 108 are modeled as Coulomb counters. In other embodiments, the setup of the ESS may be different. Once the DoE is set up, it is simulated based on certain assumptions.

In one embodiment, the DoE is simulated using a moderate fidelity model. In some embodiments, the variable μ is the current split factor that determines the current split between a battery 112 and a capacitor 108. The variable μ is modeled as a function of the battery 112 range kWh, the supercapacitor 108 kWh, the supercapacitor 108 instantaneous state of charge (SoC), and the battery 112 chemistry. The variable μ is determined by carrying out simulations comprising the battery 112 range and the supercapacitor 108 range for a specific chemistry.

The split factor controller decides the split factor between the battery 112 and the supercapacitor 108. In some embodiments, the controller decides the split based on rule-based splitting. In rule-based splitting, the controller decides the split factor as a function of the battery 112 and supercapacitor 108 SoC with the supercapacitor 108 having a limit of 100° C. In some embodiments, the controller decides the split based on fixed splitting. In fixed splitting, the controller targets a constant power split between the battery 112 and the supercapacitor 108 at all times with the supercapacitor 108 having a limit of 100° C.

In some embodiments, other variants may be utilized. In some embodiments, the controller may decide the power split based on eHorizon or forward-looking data. In some other embodiment, the intelligent control of the power split may involve other storage elements.

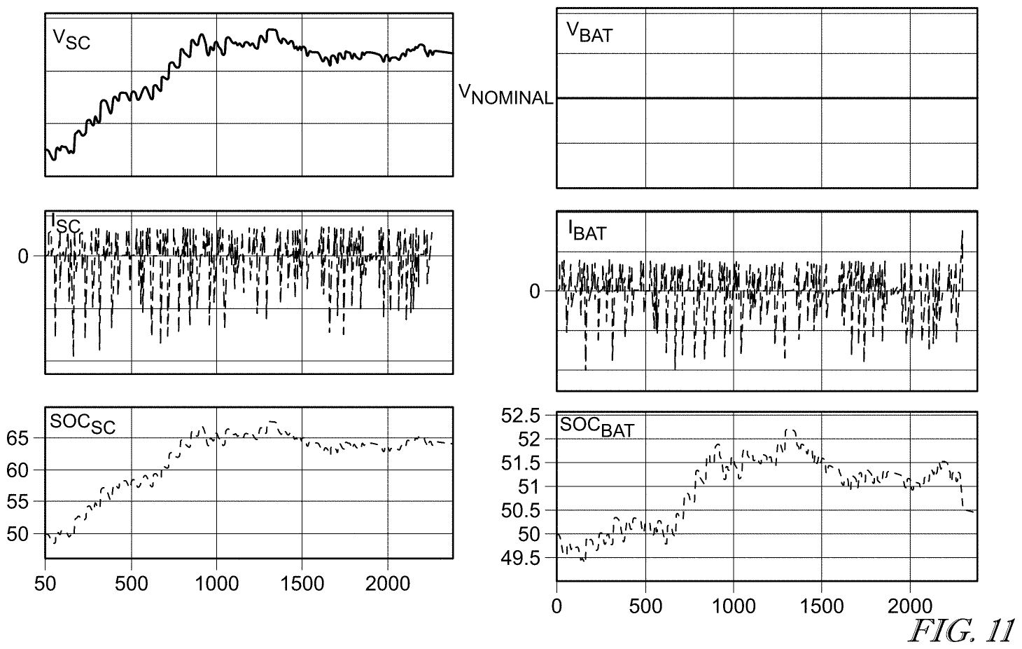

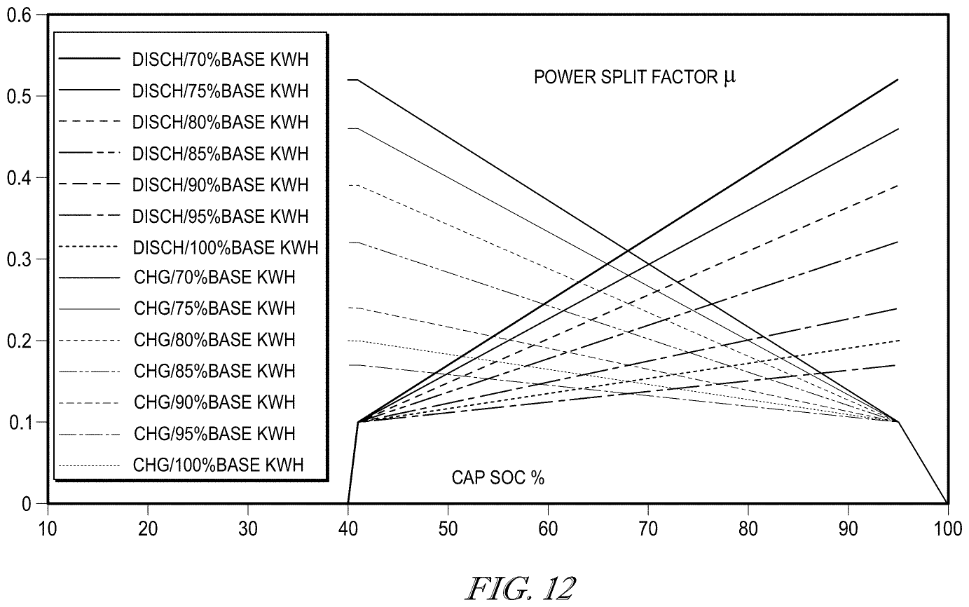

In one embodiment, the Type 1 chemistry battery 112 range is about 100 kWh, the supercapacitor 108 range is about 1 kWh and the split factor is about 0.5. Referring now to FIG. 11, the graph illustrates the typical waveforms for such an embodiment during one specific route if the utilization of the supercapacitor 108 is in the range of about 50% to about 68% of its capacity. The current pulse at the end of the cycle indicates the SoC balance of the battery 112. FIG. 12 illustrates the current split factor μ based on rule based splitting. The battery 112 usage is in the rage of about 70% to about 100% of its base battery 112 kWh, and the supercapacitor 108 is in the range of about 0 kWh to about 5 kWh.

In one embodiment, a DC/DC converter 110 is included in the system architecture. As the efficiency of the DC/DC converter 110 is a function of its input voltage, which drops off rapidly at lower input voltages, the supercapacitor 108-DC/DC 110 subsystem efficiency drops as well. Therefore, maintenance of the voltage (related to SOC state of charge) of the DC/DC converter 110 at optimal conditions is important.

The supercapacitor 108 needs to be managed appropriately for good efficiency during usage, and cannot be discharged completely. The supercapacitor 108 efficiency is dependent on the voltage (SoC) and the current (power). In some embodiments, the supercapacitor 108 may operate in the range of about 40% of SoC to about 100% of SoC, including any specific or range of voltage (SoC) comprised therein, in order to avoid poor efficiency operation or performance

A post-processing step 318 in the present method 300 takes the output of the DoE runs, and finds the optimal battery 112/capacitor 108 combination that meets the selection criteria during real time control. In some embodiments, the post-processing 318 is done offline to LUTs that may be used during this intelligent control method 300 of the power split. Post-processing 318 of the DoE is used to determine the battery 112 life, supercapacitor 108 life, and to evaluate TCO calculations in order to identify optimum solutions for each vehicle 100 or powertrain 200 application depending on the route, conditions, and/or load demands

Factors considered during post-processing 318 comprise expected capacitor 108 life, expected battery 112 life, and battery 112 C-rate. Additionally, certain throughput based life assumptions may be made during post-processing 318. Post-processing 318 assumptions may also comprise power source (102, 108, 112) usage based on number of days per year and the number of hours per day as identified in the vehicle 100 or powertrain 200 mission. The battery 112 and capacitor 108 assumptions are modifiable inputs and are capable of variation over time. In some embodiments, LUTs may be created by running simulations based on post-processing 318 assumptions comprising battery 112 life, supercapacitor 108 life, battery 112 chemistry, supercapacitor 108 chemistry, or vehicle 100 or powertrain 200 routes or conditions.

### EXAMPLES

### Example 1: DoE for a Combined Battery and Supercapacitor Architecture

A 3-factor DoE is executed with a battery 112 size of 1 kWh, a supercapacitor 108 size of 0.1 kWh, and a split factor of 0.1. Battery 112 assumptions include 80% usage range, 96% efficiency, and 2500 base cycles. Supercapacitor 108 assumptions include a C-rate of 100° C., 60% usable range, 96% efficiency, and 1 million base cycles. DC/DC 110 assumptions include 96% efficiency. The simulation splits this power profile between the battery 112 and supercapacitor 108 while respecting supercapacitor 108 limits such as SoC range at any given time and at any given power rate. The split factor governs how much power at any moment is sourced from the battery 112 and how much is sourced from the supercapacitor 108. For instance, a split factor of 0.3 implies 30% is sourced from the supercapacitor 108 and 70% is sourced from the battery 112. The result of such a simulation is a power profile for both the battery 112 and the supercapacitor 108, from which life and performance can be determined.

### Example 2: Different Applications in a BEV

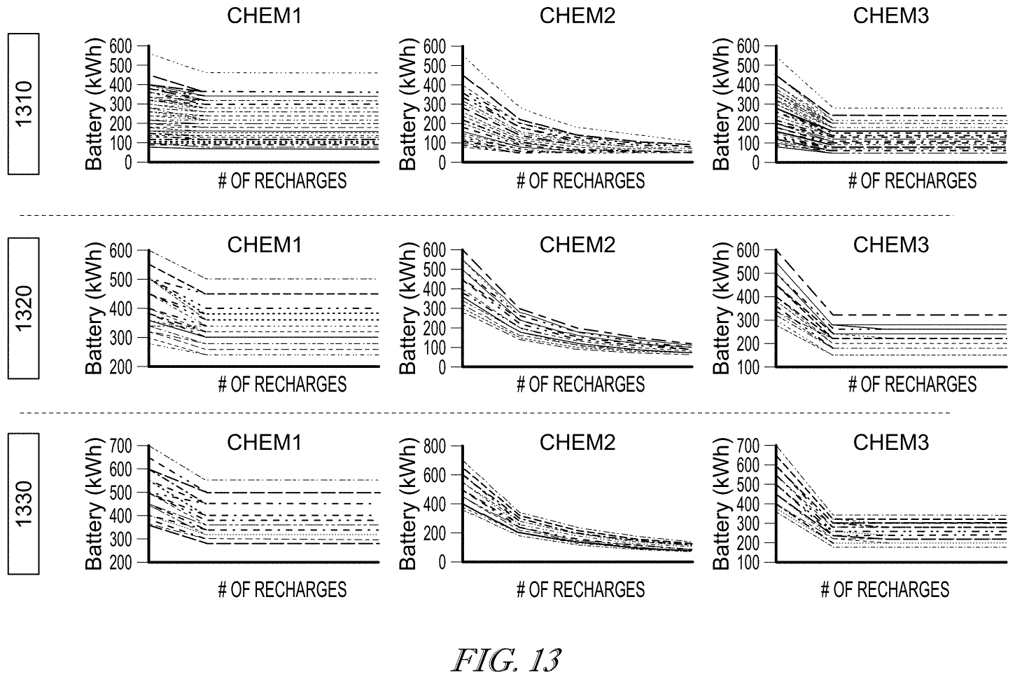

FIG. 13 illustrates the impact of the number of battery 112 recharges on different sized batteries 112 that are evaluated for three different applications and for multiple routes in a BEV 100. Each curve is a different route. Application 1 involves an average speed of <35 mph for 6 hours per day (0-210 miles/day). Application 2 involves an average speed of <35 mph for 5 hours per day (>175-250 miles/day). Application 3 involves an average speed of <50 mph for 4 hours per day (>200 miles/day), and a usage of 286 days per year, for 6 years. The following battery 112 chemistry is assumed: Type 1: 2500 cycles, Type 2: 15000 cycles, and Type 3: 4000 cycles.

### Example 3: Different Applications in a FCEV

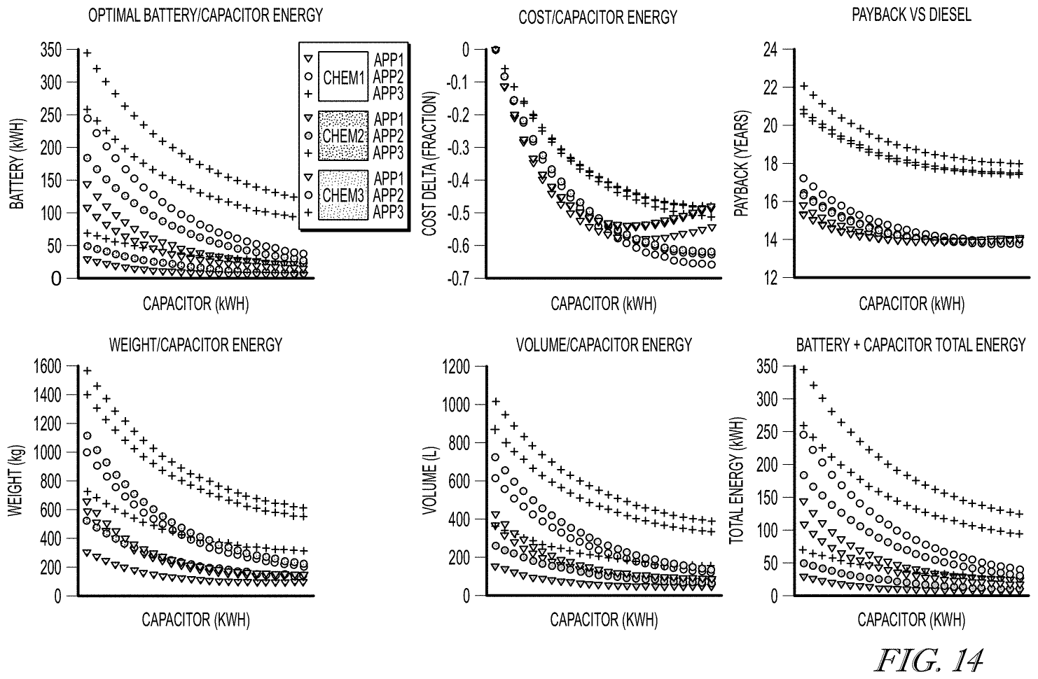

FIG. 14 illustrates the optimal battery 112/supercapacitor 108 energy, total battery 112 plus supercapacitor 108 energy, and payback vs diesel as evaluated for three different applications in a FCEV 100 (e.g., a 255 kW transit bus FCEV) for various battery 112 chemistry compositions. Application 1 involves an average speed of <15 mph for 16 hours per day (0-240 miles/day). Application 2 involves an average speed of >15 mph for 16 hours per day (>240-320 miles/day). Application 3 involves an average speed of >20 mph for 16 hours per day (>320 miles/day). The following battery 112 characteristics are assumed: Type 1 battery—life>6 years, 3000 cycles and C-rate: <3, Type 3 battery—life>6 years, 15000 cycles and C-rate: <5, Type 2 battery—life>6 years, 4000 cycles and C-rate: <4. A supercapacitor 108 life >6 years and 1 million cycles is assumed.

### Example 4: Different Applications in a School Bus BEV

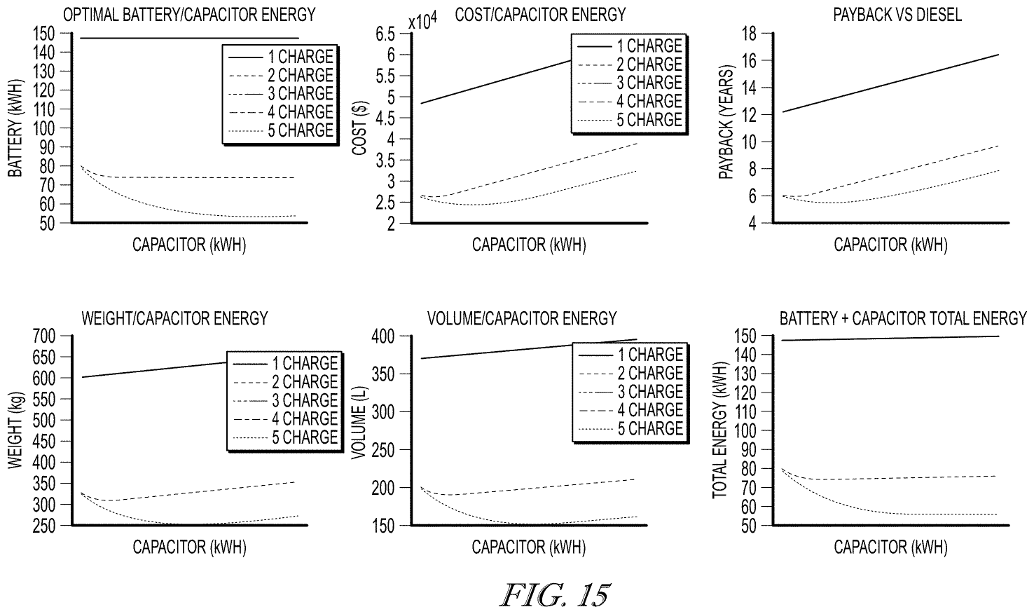

FIG. 15 illustrates the multiple routes average optimal battery 112/supercapacitor 108 energy, total battery 112 plus supercapacitor 108 energy, and payback vs diesel as evaluated for three different applications in a school bus BEV 100. Application 1 involves an average speed of <15 mph for 4 hours per day (0-60 miles/day). Application 2 involves an average speed of >15 mph for 4 hours per day (>60-80 miles/day). Application 3 involves an average speed of >15 mph for 4 hours per day (>680 miles/day). A battery 112 life >6 years, 1500 cycles and C-rate <2 is assumed. A supercapacitor 108 life >6 years and 1 million cycles is assumed.

### Example 5: Different Applications in BEV

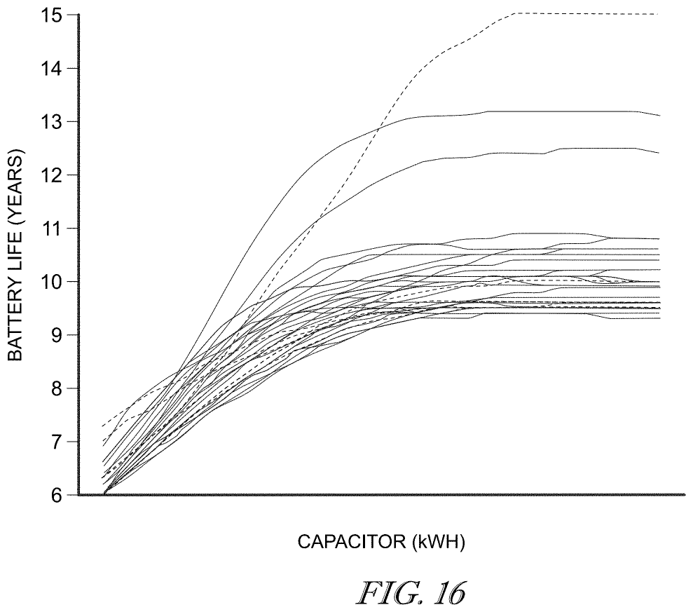

FIG. 16 illustrates the battery 112 life extension when using a supercapacitor 108 in a transit bus BEV 100. The BEV 100 has a 600 kWh/day limit and a single recharge per day for multiple routes. Application 1 involves an average speed of <15 mph for 16 hours per day (0-240 miles/day). Application 2 involves an average speed of >15 mph for 16 hours per day (>240-320 miles/day). A battery 112 life >6 years, 1500 cycles and C-rate <2 is assumed. A supercapacitor 108 life >6 years and 1 million cycles is assumed.

In some embodiments, the variables β and γ are constant. In some embodiments, β and γ can change. In some embodiments, the intelligent control system and method 300 may make use of eHorizon information to determine power change or the values of the control variables β and γ. This method 300 may be used to plan a look ahead based life management strategy. If specific loading conditions are expected, the system power devices or sources may be pre-conditioned to anticipate the maneuvers and optimize life consumption. In some embodiments, supercapacitors 108 may be replaced with any high cycle life, high power devices, like flywheel motors or pneumatic systems.

The intelligent control system and method 300 described here is applicable to all vehicles 100 , powertrains 200, and/or industrial markets and applications that can make use of a fuel cell 102 or hybrid or BEV powertrains 200. This method 300 has the potential to improve maintenance costs, increase change intervals, or result in less downtime. In some embodiments, the need for Li-ion battery 112 within a FCEV 100 may be eliminated, and the fuel cell 102 may be supported only by a supercapacitor 108.

In some embodiments, environment variations may also be factored into the intelligent control method 300. For example, startup of fuel cells 102 can be challenging in low temperatures, requiring low or high voltage (e.g., 12 or 24 V) batteries 112 to support fuel cell 102 heaters as the Li-ion battery 112 may not be able to support them. In such instances, supercapacitors 108 systems may provide a compelling and alternative option to batteries 112 that may further reduce system cost and complexity.

Typically, fuel cells 102 require some form of boosted fresh air to operate under high altitude conditions. At higher altitudes, blowers or compressors may fall short of providing the needed air through power transients as effectively as they can at lower altitudes, which is required for optimal fuel cell 102 performance and operations. A supercapacitor 108 system may be effective at compensating for this performance shortfall without significant impact to overall life of the fuel cell 102 or other power source components (e.g., battery 112).

The following numbered embodiments are contemplated and are non-limiting.
1. A method of intelligently controlling one or more power sources to maximize life of a powertrain, comprising:
   measuring in real time a power loading requirement of the powertrain;
   identifying at least two variables that determine a power demand split in the powertrain;
   splitting power between the one or more power sources of the powertrain based on the at least two identified variables;
   monitoring the life of the one or more power sources of the powertrain; and
   controlling power of the one or more power sources to maximize life of the powertrain;
   wherein the one or more power sources of the powertrain comprises at least one fuel cell and an energy storage system, and
   wherein the at least two variables that determine the power demand split between the one or more power sources of the powertrain comprises a power split variable (β) and a fuel cell transient loading variable (γ).
2. The method of clause 1, any other suitable clause, or any combination of suitable clauses, wherein the energy storage system comprises a battery.
3. The method of clause 1, any other suitable clause, or any combination of suitable clauses, wherein the energy storage system comprises a supercapacitor.
4. The method of clause 1, any other suitable clause, or any combination of suitable clauses, wherein the at least two variables further comprise a fuel cell load following factor (α).
5. The method of clause 1, any other suitable clause, or any combination of suitable clauses, further comprising correcting the value of the at least two variables to compensate for expected impact on life of the one or more power sources of the powertrain.
6. The method of clause 1, any other suitable clause, or any combination of suitable clauses, further comprising determining the life of the one or more power sources.
7. The method clause 1, any other suitable clause, or any combination of suitable clauses, wherein the energy storage system comprises at least one battery and at least one supercapacitor, wherein the power split variable (β) determines the power split between the battery and the supercapacitor.
8. The method of clause 1, any other suitable clause, or any combination of suitable clauses, wherein identifying variables that determine the power demand split in the powertrain comprises using data generated offline.
9. The method of clause 8, any other suitable clause, or any combination of suitable clauses, wherein the data generated offline is based on a Look Up Table.
10. The method of clause 8, any other suitable clause, or any combination of suitable clauses, wherein the data generated offline comprises incorporating predictive mapping or routing information.
11. The method of clause 10, any other suitable clause, or any combination of suitable clauses, wherein the predictive mapping or routing data is acquired from electronic or online routing sources.
12. The method of clause 1, any other suitable clause, or any combination of suitable clauses, wherein the powertrain is comprised in a vehicle.
13. The method of clause 12, any other suitable clause, or any combination of suitable clauses, wherein the vehicle is an electric vehicle.
14. The method of clause 13, any other suitable clause, or any combination of suitable clauses, wherein the electric vehicle is a fuel cell electric vehicle (FCEV).
15. The method of clause 13, any other suitable clause, or any combination of suitable clauses, wherein the electric vehicle is a battery electric vehicle (BEV).
16. A method of intelligently controlling one or more power sources to maximize life of a vehicle, comprising:
   measuring in real time a power loading requirement of the vehicle;
   identifying at least two variables that determine a power demand split in the vehicle;
   splitting power between the one or more power sources of the vehicle based on the at least two identified variables;
   monitoring the life of the one or more power sources of the vehicle; and
   controlling power of the one or more power sources to maximize life of the vehicle;
      wherein the one or more power sources of the vehicle comprises at least one fuel cell and an energy storage system, and
      wherein the at least two variables that determine the power demand split between the one or more power sources of the vehicle comprises a power split variable (β) and a fuel cell transient loading variable (γ).
17. The method of clause 16, any other suitable clause, or any combination of suitable clauses, wherein the energy storage system comprises a battery.
18. The method of clause 16, any other suitable clause, or any combination of suitable clauses, wherein the energy storage system comprises a supercapacitor.
19. The method of clause 16, any other suitable clause, or any combination of suitable clauses, wherein the at least two variables further comprise a fuel cell load following factor (α).
20. The method of clause 16, any other suitable clause, or any combination of suitable clauses, further comprising correcting the value of the at least two variables to compensate for expected impact on life of the one or more power sources of the vehicle.
21. The method of clause 16, any other suitable clause, or any combination of suitable clauses, further comprising determining the life of the one or more power sources.
22. The method clause 16, any other suitable clause, or any combination of suitable clauses, wherein the energy storage system comprises at least one battery and at least one supercapacitor, wherein the power split variable (β) determines the power split between the battery and the supercapacitor.
23. The method of clause 16, any other suitable clause, or any combination of suitable clauses, wherein identifying variables that determine the power demand split in the vehicle comprises using data generated offline.
24. The method of clause 23, any other suitable clause, or any combination of suitable clauses, wherein the data generated offline is based on a Look Up Table.
25. The method of clause 23, any other suitable clause, or any combination of suitable clauses, wherein the data generated offline comprises incorporating predictive mapping or routing information.
26. The method of clause 25, any other suitable clause, or any combination of suitable clauses, wherein the predictive mapping or routing data is acquired from electronic or online routing sources.
27. The method of clause 16, any other suitable clause, or any combination of suitable clauses, wherein a powertrain is comprised in the vehicle.
28. The method of clause 16, any other suitable clause, or any combination of suitable clauses, wherein the vehicle is an electric vehicle.
29. The method of clause 28, any other suitable clause, or any combination of suitable clauses, wherein the electric vehicle is a fuel cell electric vehicle (FCEV).
30. The method of clause 28, any other suitable clause, or any combination of suitable clauses, wherein the electric vehicle is a battery electric vehicle (BEV).
31. An intelligently controlled powertrain, comprising:
   a power load requirement of the powertrain;
   one or more power sources to provide the power load requirement of the powertrain, wherein life of the one or more power sources of the powertrain is monitored or controlled to maximize life of the powertrain;
   wherein the one or more power sources of the powertrain comprises at least one fuel cell and an energy storage system, and
   a power demand split between the one or more power sources of the powertrain,
wherein the power demand split is identified based on at least two variable and the at least two variables comprise a power split variable (β) and a fuel cell transient loading variable (γ).
32. The powertrain of clause 31, any other suitable clause, or any combination of suitable clauses, wherein the energy storage system comprises a battery.
33. The powertrain of clause 31, any other suitable clause, or any combination of suitable clauses, wherein the energy storage system comprises a supercapacitor.
34. The powertrain of clause 31, any other suitable clause, or any combination of suitable clauses, wherein the at least two variables further comprise a fuel cell load following factor (α).
35. The powertrain of clause 31, any other suitable clause, or any combination of suitable clauses, wherein a value of the at least two variables is corrected to compensate for expected impact on life of the one or more power sources of the powertrain.
36. The powertrain of clause 31, any other suitable clause, or any combination of suitable clauses, wherein life of the one or more power sources is determined.
37. The powertrain clause 31, any other suitable clause, or any combination of suitable clauses, wherein the energy storage system comprises at least one battery and at least one supercapacitor, wherein the power split variable (β) determines the power split between the battery and the supercapacitor.
38. The powertrain of clause 31, any other suitable clause, or any combination of suitable clauses, wherein the at least two variables that determine the power demand split in the powertrain comprise data generated offline.
39. The powertrain of clause 38, any other suitable clause, or any combination of suitable clauses, wherein the data generated offline is based on a Look Up Table.
40. The powertrain of clause 38, any other suitable clause, or any combination of suitable clauses, wherein the data generated offline comprises predictive mapping or routing information.
41. The powertrain of clause 40, any other suitable clause, or any combination of suitable clauses, wherein the predictive mapping or routing data is acquired from electronic or online routing sources.
42. The powertrain of clause 41, any other suitable clause, or any combination of suitable clauses, wherein the powertrain is comprised in a vehicle.
43. The powertrain of clause 42, any other suitable clause, or any combination of suitable clauses, wherein the vehicle is an electric vehicle.
44. The powertrain of clause 43, any other suitable clause, or any combination of suitable clauses, wherein the electric vehicle is a fuel cell electric vehicle (FCEV).
45. The powertrain of clause 43, any other suitable clause, or any combination of suitable clauses, wherein the electric vehicle is a battery electric vehicle (BEV).
46. An intelligently controlled vehicle, comprising:
   a power load requirement of a vehicle;
   one or more power sources to provide the power load requirement of the vehicle, wherein life of the one or more power sources of the vehicle is monitored or controlled to maximize life of the vehicle;
   wherein the one or more power sources of the vehicle comprises at least one fuel cell and an energy storage system, and
   a power demand split between the one or more power sources of the vehicle,
wherein the power demand split is identified based on at least two variable and the at least two variables comprise a power split variable (β) and a fuel cell transient loading variable (γ).
47. The vehicle of clause 46, any other suitable clause, or any combination of suitable clauses, wherein the energy storage system comprises a battery.
48. The vehicle of clause 46, any other suitable clause, or any combination of suitable clauses, wherein the energy storage system comprises a supercapacitor.
49. The vehicle of clause 46, any other suitable clause, or any combination of suitable clauses, wherein the at least two variables further comprise a fuel cell load following factor (α).
50. The vehicle of clause 46, any other suitable clause, or any combination of suitable clauses, wherein a value of the at least two variables is corrected to compensate for expected impact on life of the one or more power sources of the vehicle.
51. The vehicle of clause 46, any other suitable clause, or any combination of suitable clauses, wherein life of the one or more power sources is determined.
52. The vehicle clause 46, any other suitable clause, or any combination of suitable clauses, wherein the energy storage system comprises at least one battery and at least one supercapacitor, wherein the power split variable (β) determines the power split between the battery and the supercapacitor.
53. The vehicle of clause 46, any other suitable clause, or any combination of suitable clauses, wherein the at least two variables that determine the power demand split in the vehicle comprise data generated offline.
54. The vehicle of clause 53, any other suitable clause, or any combination of suitable clauses, wherein the data generated offline is based on a Look Up Table.
55. The vehicle of clause 53, any other suitable clause, or any combination of suitable clauses, wherein the data generated offline comprises predictive mapping or routing information.
56. The vehicle of clause 55, any other suitable clause, or any combination of suitable clauses, wherein the predictive mapping or routing data is acquired from electronic or online routing sources.
57. The vehicle of clause 46, any other suitable clause, or any combination of suitable clauses, wherein a powertrain is comprised in the vehicle.
58. The vehicle of clause 46, any other suitable clause, or any combination of suitable clauses, wherein the vehicle is an electric vehicle.
59. The vehicle of clause 58, any other suitable clause, or any combination of suitable clauses, wherein the electric vehicle is a fuel cell electric vehicle (FCEV).
60. The vehicle of clause 58, any other suitable clause, or any combination of suitable clauses, wherein the electric vehicle is a battery electric vehicle (BEV).

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method of intelligently controlling one or more power sources to maximize life of a powertrain, comprising:
measuring in real time a power loading requirement of the powertrain;
identifying at least two variables that determine a power demand split in the powertrain;
splitting power between the one or more power sources of the powertrain based on the at least two identified variables;
monitoring the life of the one or more power sources of the powertrain; and
controlling power of the one or more power sources to maximize life of the powertrain;
wherein the one or more power sources of the powertrain comprises at least one fuel cell and an energy storage system, and
wherein the at least two variables that determine the power demand split between the one or more power sources of the powertrain comprises a power split variable (β) and a fuel cell transient loading variable (γ).

2. The method of claim 1, wherein the energy storage system comprises a battery.

3. The method of claim 1, wherein the energy storage system comprises a supercapacitor.

4. The method of claim 1, wherein the at least two variables further comprise a fuel cell load following factor (α).

5. The method of claim 1, further comprising correcting the value of the at least two variables to compensate for expected impact on life of the one or more power sources of the powertrain.

6. The method of claim 1, further comprising determining the life of the one or more power sources.

7. The method claim 1, wherein the energy storage system comprises at least one battery and at least one supercapacitor, wherein the power split variable (β) determines the power split between the battery and the supercapacitor.

8. The method of claim 1, wherein identifying variables that determine the power demand split in the powertrain comprises using data generated offline.

9. The method of claim 8, wherein the data generated offline is based on a Look Up Table.

10. The method of claim 8, wherein the data generated offline comprises incorporating predictive mapping or routing information.

11. The method of claim 10, wherein the predictive mapping or routing data is acquired from electronic or online routing sources.

12. The method of claim 1, wherein the powertrain is comprised in a vehicle.

13. The method of claim 12, wherein the vehicle is an electric vehicle.

14. The method of claim 13, wherein the electric vehicle is a fuel cell electric vehicle (FCEV).

15. The method of claim 13, wherein the electric vehicle is a battery electric vehicle (BEV).

16. A method of intelligently controlling one or more power sources to maximize life of a vehicle, comprising:
measuring in real time a power loading requirement of the vehicle;
identifying at least two variables that determine a power demand split in the vehicle;
splitting power between the one or more power sources of the vehicle based on the at least two identified variables;
monitoring the life of the one or more power sources of the vehicle;
correcting the value of the at least two variables to compensate for expected impact on life of the one or more power sources of the vehicle; and
controlling power of the one or more power sources to maximize life of the vehicle;
wherein the one or more power sources of the vehicle comprises at least one fuel cell and an energy storage system, and wherein the at least two variables that determine the power demand split between the one or more power sources of the vehicle comprises a power split variable (β) and a fuel cell transient loading variable (γ).

17. The method of claim 16, wherein the energy storage system comprises a battery.

18. The method of claim 16, wherein the energy storage system comprises a supercapacitor.

19. The method of claim 16, wherein the at least two variables further comprise a fuel cell load following factor (α).

20. The method of claim 16, wherein the energy storage system comprises at least one battery and at least one supercapacitor, wherein the power split variable (β) determines the power split between the battery and the supercapacitor.
